(19) United States
(12) Patent Application Publication
(10) Pub. No.: US 2019/0163832 A1
(43) Pub. Date: May 30, 2019

(54) PREDICTIVE SEARCH CONTEXT SYSTEM FOR LOCATION INTERCEPT

(71) Applicant: T-Mobile USA, Inc., Bellevue, WA (US)

(72) Inventors: Aaron Drake, Sammamish, WA (US); Rami Al-Kabra, Bothell, WA (US)

(21) Appl. No.: 15/827,869

(22) Filed: Nov. 30, 2017

(51) Int. Cl. G06F 17/30; H04L 29/08

(52) U.S. Cl. CPC G06F 17/30867; G06F 17/3087; G06F 17/3097; H04L 67/22; G06F 17/30997

(57) ABSTRACT

This disclosure describes techniques for analyzing search metadata associated with a client-initiated search performed via an internet search engine. Particularly, a Predictive Search Context (PSC) System is described that may analyze search metadata relative to client behavior data to provide a client with one or more recommendations. The recommendations may relate to an event, merchant, place, product, service, and/or category thereof. Further, the PSC system may use client behavior data (i.e., client behavior model) associated with a client, to predict a next, or near to next, probable location of the client. In this example, the PSC system may generate client behavior data based on client-initiated searches performed on client devices operated exclusively or non-exclusively by the client. In doing so, the PSC system may analyze search metadata associated with one of the client devices to identify the client and determine a next, or near to next probable location of the client.

### BACKGROUND

Present day, computing technology over a telecommunications network may allow consumers to initiate an internet search for a variety of topics that appeal to their individual interests and preferences. In some examples, consumers may search for information of interest such as events, locations, places, products, or services, and/or so forth. A review of a client' interest search history may provide a service provider with an insight into a consumer's behavior in combination with their interests and preferences.

However, privacy and security priorities may control the extent to which service providers review a client's internet search history, particularly keywords used to perform a client-initiated search via an internet search engine. This in turn limits the potential application and use of client-initiated searches as a means of understanding a client's behavior and/or tailoring advertisements to reflect a client's interests and preferences.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a schematic view of a computing environment that facilitates an analysis of search metadata associated with a client-initiated search performed via an internet search engine.

FIG. 2 illustrates a block diagram of a PSC system that is configured to analyze search metadata associated with a client-initiated search and further present at least one recommendation to the client device that performed the client-initiated search.

FIG. 3 illustrates a block diagram of a PSC system that is configured to determine a next, or near to next, probable location of a client.

FIG. 4 illustrates a block diagram of a PSC system that can analyze search metadata associated with a client-initiated search performed via an internet search engine.

FIG. 5 illustrates a PSC system process to generate at least one recommendation to present to a client, in response to an analysis of search metadata of a client initiated search, via an internet search engine.

FIG. 6 illustrates a PSC system process to select at least one recommendation for presentation to a client device, based at least in part on an analysis of client behavior data.

FIG. 7 illustrates a PSC system process to determine a next, or near to next, probable location of a client based on a historical client-initiated searches performed on one or more client devices operating on a telecommunications network.

FIG. 8 illustrates a PSC system process to predict a next, or near to next, location of a client based on monitoring instances of client-initiated searches performed by one or more client devices that operated exclusively or non-exclusively by a client on the telecommunications network.

### DETAILED DESCRIPTION

This disclosure describes techniques that facilitate analyzing search metadata describing information about a client-initiated search performed via an internet search engine. Particularly, a service provider of a telecommunications network, may seek to provide its clients with targeted recommendations, based on a knowledge base of client interests, preferences, and behavior. Recommendations may relate to an event, merchant, place, location, product, service, and/or category thereof. Without limitation, a service provider may develop a knowledge base of client interests, preferences, and behavior by analyzing client-initiated searches performed via internet search engines over the telecommunications network. In this way, the service provider need only survey a client's use of telecommunications services (i.e., client-initiated search performed over the telecommunications network) to generate client behavior data that describes client interests, preferences, and behavior. However, privacy and security priorities may control the extent to which the service provider may access keywords used by the client to perform client-initiated searches. Therefore, absent access to keywords, a Predictive Search Context (PSC) system is described that may retrieve search metadata that describes information about a client-initiated search. The PSC system may further analyze the search metadata to determine a search context related to the client-initiated search. The search context may be used to generate one or more targeted recommendations for the client based at least in part on developed client behavior data.

Further, the PSC system may develop a client behavior model, based at least in part on client behavior data. The client behavior model may describe a client's internet search behavior over a predetermined time interval. In one example, the PSC system may use the client behavior model to provide targeted recommendations. In another example, the PSC system may use the client behavior model to locate a client based on a profile of instances of historical client-initiated searches and corresponding search metadata. In other words, the PSC system may use the client behavior model to identify a client by way of identifying a pattern of client-initiated searches performed by the client over a predetermined time interval.

More specifically, the PSC system may analyze the client behavior model to predict that the client has conducted a client-initiated search on a client device operating on the telecommunications network, based at least in part on instances of historical search metadata and associated time-stamps. Alternatively, or additionally, the PSC system may use the client behavior model to monitor one or more client devices associated with the client and further predict whether a current client-initiated search detected on one of the client devices is likely associated with the client, based on a correlation of data patterns between the search metadata of the current client-initiated search and instances of historical search metadata.

In the illustrated example, the PSC system may retrieve search metadata of a client-initiated search that is conducted via an internet search engine. The search metadata may describe information about the client-initiated search, without expressly reciting keywords entered by the client. By way example, the search metadata may include one or more of a device identifier associated with a client device that performed the client-initiated search, an Internet Protocol (IP) address that corresponds to a subsequent internet search result, a number of bits associated with a character string (i.e., character string of the keyword(s) entered by the client) of the client-initiated search, or a time-stamp associated with the client-initiated search. The PSC system may retrieve the search metadata from one or more client devices operating on a telecommunications network, on a continuous basis, per a predetermined schedule, or in response to a triggering event. The predetermined schedule may be based on a time interval of 30 minutes, one hour, 12 hours, or 24 hours. Any time interval is possible. Further, the triggering event may correspond to receipt of an indication, from a client device, that the client-initiated search has been performed.

Particularly, the PSC system may use the device identifier of the client device to retrieve location data from one or more base-station node(s) associated with the telecommunications network. The location data may be used to identify the geographic location of the client device at a point in time that substantially correlates with a client-initiated search. Additionally, or alternatively, the PSC system may use the device identifier to identify a type of internet search engine used, by the client, to perform the client-initiated search. By way example, each client device type may use default search engines that typically employ their own proprietary search algorithms. In this example, by identifying the search engine, a corresponding search algorithm that is used to perform a client-initiated search, the PSC system may refine its analysis of search metadata to determine a search context that corresponds to the client-initiated search.

Moreover, the PSC system may retrieve one or more IP addresses accessed by the client device for a predetermined time interval, in response to detecting a client-initiated search. By way of example, an internet search engine may process a client-initiated search and display a list of search results, of which the client may make one or more selections. The PSC system may selectively retrieve multiple IP addresses for the purpose of retrieving an IP address of each search result selection, rather than an IP address of the list of search results. The PSC system may retrieve one or more IP addresses for a predetermined time interval that is determined by an operator of the PSC system, the service provider, or a combination of both. Alternatively, or additionally, the PSC system may retrieve substantially all IP addresses accessed by the client device until a next client-initiated search is performed.

Further, the PSC system may retrieve a number of bits associated with a character string (i.e., character string of the keyword(s) entered by the client) of the client-initiated search for the purpose of determining a complexity of the client-initiated search. By way of example, consider a client-initiated search that uses a keyword “cars.” Since the PSC system will not have access to the keyword string “cars” the PSC system may deduce that the keyword string is simple based on the number of bits associated with the character string. In doing so, the PSC system may determine that the client-initiated search is likely aimed towards a general search category, and in doing so, determine a general search context of relating to the “cars.” However, consider another client-initiated search that uses a keyword string “1969 Red Mustang in mint condition.” Again, since the PSC system will not have access to the keyword string, the PSC system may deduce that the keyword string is complex based on the number of bits associated with the character string. In this example, the PSC system may analyze subsequent IP addresses accessed by the client device to determine a narrower search context relating to “mustangs” in lieu of “cars.” The number of bits that the PSC system uses as an indication that a keyword string is simple or complex may vary depending on the search context, and may be further defined by an operator of the PSC system, the service provider, or a combination of both.

Further, the PSC system may analyze the search metadata to determine a search context that corresponds to the client-initiated search. In some examples, the PSC system may use one or more trained machine learning models to correlate data patterns between the search metadata and client behavior data associated with the client. The client behavior data may include instances of historical search metadata associated with the client or client device, corresponding associations to search contexts, client profile data associated with the client that is maintained by the telecommunications service provider, or any combination thereof. Additionally, or alternatively, the data patterns may correlate one or more a particular day of the week, a particular time of day that client-initiated searches are performed. Client profile data may include a residential address, a business address, employment status, employment place, level of education, and/or so forth. Additionally, client behavior data may include associations to recommendations previously presented to a client based on historical search metadata and corresponding search contexts.

In one example, the PSC system may use the one or more trained machine learning models to determine a similarity between the search metadata of a client-initiated search and instances of historical search metadata associated with the client. In doing so, the PSC system may determine a search context based at least in part on the similarity between the search metadata and an instance of historical search metadata being greater than a predetermined similarity threshold. In some examples, the PSC system may assign a similarity score to each instance of historical search metadata based on a degree of correlation to the search metadata of the client-initiated search. The similarity score may be an alpha-numeric expression (i.e., 0 to 10, or A to F), a descriptive expression (i.e., low, medium, or high), based on color (i.e., red, yellow, or green), or any other suitable scale that reflects a degree of correlation between the search metadata and instance of historical search metadata. Further, the predetermined similarity threshold may correspond to a mean-value similarity score (i.e., 5, C, medium, or yellow). A mean-value similarity score may reflect a correlation of some, but not all, components of search metadata (i.e., IP address accessed by a client device subsequent to a client-initiated search, number of bits of character string, time-stamp that corresponds to the client-initiated search, device identifier, and/or so forth). A similarity score that is above the predetermined similarity threshold (i.e., 6 to 10, high, or green) may be considered as having a good correlation of at least half of the components of search metadata. Alternatively, a similarity score that is less than the predetermined similarity threshold (i.e., 0 to 4, low, or red) may reflect a correlation of less than half of the components of search metadata. In various examples, the predetermined similarity threshold may be set by an operator of the PSC system, an operator of the telecommunications network, or a combination of both.

Thus, the PSC system may identify one or more instances of historical search metadata with a similarity score relative to search metadata that is greater than the predetermined similarity threshold. The PSC system may further identify historical search contexts that correspond to each of the instances of historical search metadata. In doing so, the PSC system may determine one or more search contexts for the search metadata based at least in part on the historical search contexts.

In various examples, the search context may correspond to one of an event, merchant, place, location, product, service, and/or a category thereof. In some examples, the PSC system may determine one or more search contexts that relate to a client-initiated search, based on combinations of search metadata. In one example, the PSC system may determine that the search context of a client-initiated search relates to a genre of music (i.e., category of product or service), based on IP addresses accessed by the client device following the client-initiated search. In another example, the PSC system may determine that the search context relates more specifically to music venues that perform the genre of music (i.e., category of places), based on the geographic location of the client at a point in time that a client-initiated search is performed. The PSC system may determine the geographic location of the client using the device identifier of the client device that is used to perform the client-initiated search. In another example, the PSC system may determine that the search context relates to an event (i.e., music event), or category of events (i.e., live performances or concerts) associated with the genre of music. In this example, the PSC system may identify music events that occur within a predetermined time frame following the client-initiated search, based on a time-stamp of client-initiated search. The predetermined time frame may be a time interval of one week, one month, or several months. Any time interval is possible. Further, the predetermined time frame may be set by an operator of the PSC system or telecommunications service provider.

In various examples, may retrieve, from a data store, one or more recommendations for presentation to the client device, based at least in part on the one or more search contexts. The one or more recommendations may be specific to a geographic location, a time period, or a combination of both. By way of example, the data store may maintain recommendations for a plurality of clients that operate client devices on the telecommunications network. The data store may be maintained by an operator of the PSC system, an operator of the telecommunications service provider, or a combination of both.

Additionally, the PSC system may select a recommendation from the one or more recommendations retrieved from the data store, for presentation to the client device. In some examples, the PSC system may use one or more trained machine learning models to correlate data patterns between the one or more recommendations and the client behavior data. The client behavior data may include one or more of instances of historical search metadata associated with the client device, corresponding search contexts that relate to the instances of historical search metadata, and client profile data associated with the client that is maintained by the PSC system or the telecommunications service provider. In some examples, the client behavior data may further include associations to recommendations previously presented to the client.

In some examples, the PSC system may use one or more machine learning models to assign a suitability score to each recommendation retrieved from the data store. The suitability score may reflect a degree of correlation between each recommendation retrieved from the data store and client behavior data associated with the client. By way of example, the client behavior data may include historical search metadata and associated search contexts, client interests, client preferences, geographic locations frequently visited by the client, or any combination thereof.

In a first example, consider a client performing a client-initiated search that relates to “vehicles.” The PSC system may retrieve and analyze search metadata associated with the client-initiated search and determine a search context that relates to “vehicles.” In doing so, the PSC system may retrieve one or more recommendations from a data store that relate to the search context, “vehicles.” More specifically, the PSC system may retrieve a first recommendation associated with “vintage vehicles” and a second recommendation associated with “modern vehicles.” The PSC system may further identify a client interest in “vintage vehicles” based on client behavior data. The client behavior data may correspond to historical client-initiated searches for “vintage vehicles” (i.e., instances of historical search metadata), or client profile data that reveals an interest in “vintage vehicles.” In doing so, the PSC system may assign a first suitability score to the first recommendation (i.e., vintage vehicles) that is relatively higher than a second suitability score for the second recommendation (i.e., modern vehicles).

In a second example, consider a client performing a client-initiated search that relates to a location-specific event or place. In this example, the PSC system may retrieve and analyze search metadata associated with the client-initiated search and determine a search context that relates to the event or place. In doing so, the PSC system may retrieve one or more recommendations from a data store that relate to the search context for the event or place. Further, the PSC system may determine geographic locations frequently visited by a client based on client profile data (i.e., residential address or business address), instances of historical search metadata associated with the client (i.e., device identifier in combination with location data from a base-station node), and/or corresponding associations to search contexts (i.e., events, places, location, and/or so forth). The PSC system may further generate a suitability score for each recommendation retrieved from the data store (i.e., event or place) based on a likelihood that the client will visit a respective location associated with each recommendation.

The suitability score may be an alpha-numeric expression (i.e., 0 to 10, or A to F), a descriptive expression (i.e., low, medium, or high), based on color (i.e., red, yellow, or green), or any other suitable scale that reflects a degree of correlation between a recommendation and client behavior data. Further, the PSC system may select a recommendation for presentation to a client device based on comparing the suitability score with a predetermined suitability threshold. The predetermined suitability threshold may be a mean-value suitability score (i.e., 5, C, medium, or yellow) that is used to identify which recommendations are to be sent to a client device. In one example, recommendations with a suitability score that is at or above the predetermined suitability threshold (i.e., 6 to 10, medium to high, or yellow or green) may be considered as having a good correlation with client behavior data, and thus may be presented to the client device. Alternatively, recommendations with a suitability score that is less than the predetermined suitability threshold (i.e., 0 to 4, low, or red) may be considered as having a poor correlation with client behavior data, and thus are may not be presented to the client device. In various examples, the predetermined suitability threshold may be set by an operator of the PSC system, an operator of the telecommunications network, or a combination of both.

In some examples, the PSC system may generate a client behavior model to analyze search metadata and select one or more recommendations to present to client devices associated with the client. The client behavior model may include instances of historical search metadata of client-initiated searches performed by the client via one or more client devices operating on the telecommunications network. Further, the client behavior model may include historical search contexts that correspond to the instances of historical search metadata, along with the corresponding recommendations presented to client devices associated with the client. The client behavior model may be refined to include current search metadata. Additionally, or alternatively, the client behavior model may be refined to remove search metadata and associations with corresponding search contexts and recommendations that predate a predetermined applicability time interval. In this way, the client behavior model may continuously reflect a client's most recent internet search habits. The predetermined applicability time interval may correspond to a time interval that precedes a current date. The time interval may correspond to a preceding three month, six month, one year, or two-year period. Any time interval is possible. The predetermined applicability time period may be set by an operator of the PSC system, an operator of the telecommunications network, or a combination of both.

In various examples, PSC system may be configured to determine a next, or near to next, probable location of a client operating one or more client devices on the telecommunications network. By way of example, the PSC system may receive a client location request from a law enforcement personnel, a legal partner of a client, or a legal guardian of a client, all of whom may be attempting to intercept a client. In response, the PSC system may retrieve and analyze client behavior data associated with the client. More specifically, the PSC system may analyze the client behavior data to identify data patterns between instances of historical search metadata associated with client-initiated searches.

In one example, an analysis of client behavior data may reveal that the client has most recently performed one or more client-initiated searches that relate to a particular event, merchant, place, location, product, or service. In doing so, the PSC system may determine a next, or near to next, probable location of the client, based on this analysis of client behavior data. By way of example, consider a client performing one or more client-initiated searches that relate to a live music performance. The PSC system may analyze the search metadata associated with the client-initiated searches and identify a search context that corresponds to the live music performance. In this example, the PSC system may determine a next, or near to next, probable location of the client device based on the particular location and time of the live music performance.

In another example, the analysis of client behavior data may reveal that on a particular day of the week and/or a particular time of day, the client performs one or more client-initiated searches using a particular client device. Thus, the PSC system may determine a next, or near to next, probable location of the client based on a geographic location of the client device on that particular day of week and/or at that particular time of day. In some examples, the PSC system may determine the geographic location of the particular client device based on location data from a base station node associated with the telecommunications network.

In various examples, the PSC system may monitor client-initiated searches performed on client devices, and in doing so, retrieve corresponding search metadata. The PSC system may monitor instances of search metadata on a continuous basis, per a predetermined schedule, or in response to a triggering event. The predetermined schedule may be based on a time interval of 30 minutes, one hour, 12 hours, or 24 hours. Any time interval is possible. Further, the triggering event may correspond to receipt of an indication, from one of the client devices, that a client-initiated search has been performed.

The client devices may be operated exclusively or non-exclusively by a client. By way of example, a client device that is operated exclusively may correspond to a personal client device, whereas a client device that is operated non-exclusively, may correspond to a client device shared within a workplace (i.e., a work-station computer shared among employees), family (i.e., computer device shared among family members), or community environment (i.e., computing device shared among a membership of public or private community members). The PSC system may associate a non-exclusive client device with the client based on one instance, at a point in time, of the client having authenticated their identity to the telecommunications network using the non-exclusive client device.

Moreover, the PSC system may analyze each instance of search metadata relating to a client-initiated search, and further determine a similarity (i.e., a similarity score) relative to instances of historical search metadata associated with the client. The similarity may be based at least in part on an analysis of client behavior data (i.e., client behavior model) associated with the client. In this example, the similarity score may be influenced positively or negatively by the degree of correlation between the components of search metadata (i.e., IP address accessed by a client device subsequent to a client-initiated search, number of bits of character string, time-stamp that corresponds to the client-initiated search, device identifier, and/or so forth) and the corresponding components of instances of historical search metadata. In some examples, the PSC system may determine that a client-initiated search performed on a client device is likely associated with the client based on the similarity score being greater than a predetermined similarity threshold. Further, the PSC system may determine a next, or near to next, probable location of the client, based on location data of the client device, or a search context related to the client-initiated search (i.e., search metadata), itself.

It is noteworthy, however, that despite monitoring client devices exclusively and/or non-exclusively operated by a client, the client behavior data (i.e., client behavior model) is typically derived from client-initiated searches performed on client devices exclusively operated by the client. The purpose of doing so is to avoid instances whereby another client using a shared client device is inadvertently identified as the client. That said, the PSC system may still monitor instances of client-initiated searches performed on non-exclusive client devices in an attempt to identify particular instances that were likely performed by the client.

Further, the term “techniques,” as used herein, may refer to system(s), method(s), computer-readable instruction(s), module(s), algorithms, hardware logic, and/or operation(s) as permitted by the context described above and through the document.

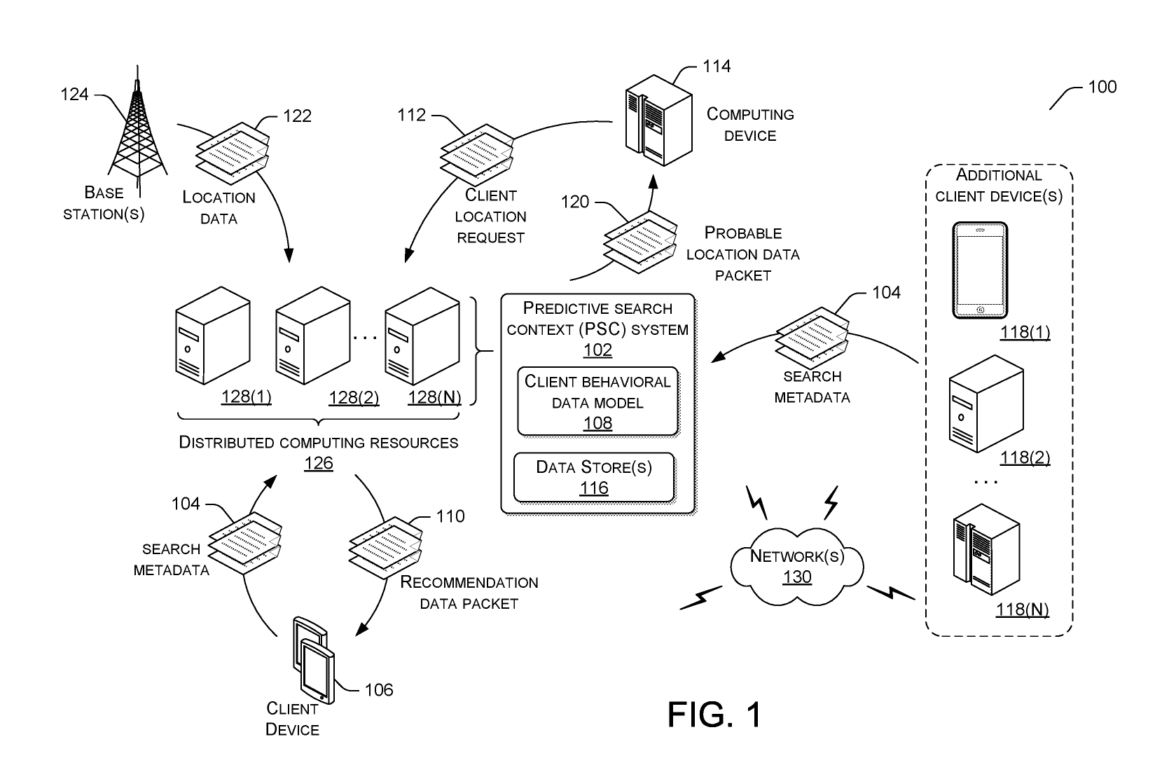

FIG. 1 illustrates a schematic view of a computing environment 100 that facilitates an analysis of search metadata associated with a client-initiated search performed via an internet search engine. Particularly, a Predictive Search Context (PSC) system 102 is configured to provide clients of a telecommunications network with targeted recommendations that relate to client interests, preferences, behavior. Further, the PSC system 102 may predict a next, or near to next, probable location of the client based on client behavior data, such as instances of historical search metadata related to historical client-initiated searches.

In the illustrated example, the PSC system 102 receive search metadata 104 that corresponds to a client-initiated search performed by client device 106 on a telecommunications network. The PSC system 102 may analyze the search metadata 104 relative to client behavior data (i.e., client behavior model 108) associated with the client, and further determine one or more recommendations for presentation to the client device 106, based on the search metadata and client behavior data. In doing so, the PSC system 102 may generate a recommendation data packet 110 for transmission to the client device 106. The recommendation data packet 110 may include computer executable instructions that automatically present the one or more recommendations on a user interface of the client device 106.

In the illustrated example, the PSC system 102 may receive a client location request 112 from a computing device 114 associated with a law enforcement agent, a legal partner, or a legal guardian. The client location request 112 may seek to determine the location of a particular client operating the client device 106 on the telecommunications network. In response to receiving the client location request 112, the PSC system 102 may retrieve a client behavior model 108 associated with the client from data store(s) 116 of the PSC system 102. Further, the PSC system 102 may retrieve search metadata 104 from additional client device(s) 118(1)-118(N) that are operated exclusively or non-exclusively by the client on the telecommunications network.

By way of example, the additional client device(s) 118(1)-118(N) that are operated exclusively by a client may correspond to a personal client device. Alternatively, the additional client device(s) 118(1)-118(N) that are operated non-exclusively by a client, may correspond to a client device shared within a workplace (i.e., a work-station computer shared among employees), family (i.e., computer device shared among family members), or community environment (i.e., computing device shared among a membership of public or private community members).

The PSC system 102 may further analyze the client behavior model 108, the search metadata 104 from the additional client device(s) 118(1)-118(N), or a combination of both, to determine a next, or near to next, probable location of the client. Moreover, the PSC system 102 may generate a probable location data packet 120 for transmission to the computing device 114. The probable location data packet 120 may include computer executable instructions that automatically present a predicted location of the client to a user interface of the computing device 114.

In some examples, the PSC system 102 may retrieve location data 122 associated with the client device 106, from base station(s) nodes 124 of the telecommunications network. The location data 122 may be used to determine the location of the client device 106 at a point in time that a client-initiated search is performed. In one example, the PSC system 102 may incorporate the location data 122 within the client behavior data (i.e., client behavior model 108). In this example, the client behavior data may be used to refine recommendations presented to the client device 106, or predict a next, or near to next, probable location of the client.

Further, the client device 106, the additional client device(s) 118(1)-118(N), and/or the computing device 114 may correspond to any sort of electronic device operating on the telecommunications network, such as a cellular phone, a smart phone, a tablet computer, an electronic reader, a media player, a gaming device, a personal computer (PC, a laptop computer), etc. The additional client device(s) 118(1)-118(N), and/or the computing device 114 may have a subscriber identity module (SIM), such as an eSIM, to identify the respective electronic device to a telecommunications service provider network (also referred to herein as “telecommunications network”).

Additionally, the PSC system 102 may operate on one or more distributed computing resource(s) 126. The one or more distributed computing resource(s) 126 may include one or more computing device(s) 128(1)-128(N) that operate in a cluster or other configuration to share resources, balance load, increase performance, provide fail-over support or redundancy, or for other purposes. The one or more computing device(s) 128(1)-128(N) may include one or more interfaces to enable communications with other networked devices, such as the client device 106, the computing device 114, the additional client device(s) 118(1)-118(N), and the base station node(s) 124, via one or more network(s) 130.

The one or more network(s) 130 may include public networks such as the Internet, private networks such as an institutional and/or personal intranet, or some combination of private and public networks. The one or more network(s) 130 can also include any type of wired and/or wireless network, including but not limited to local area network (LANs), wide area networks (WANs), satellite networks, cable networks, Wi-Fe networks, Wi-Max networks, mobile communications networks (e.g., 3G, 4G, and so forth), or any combination thereof.

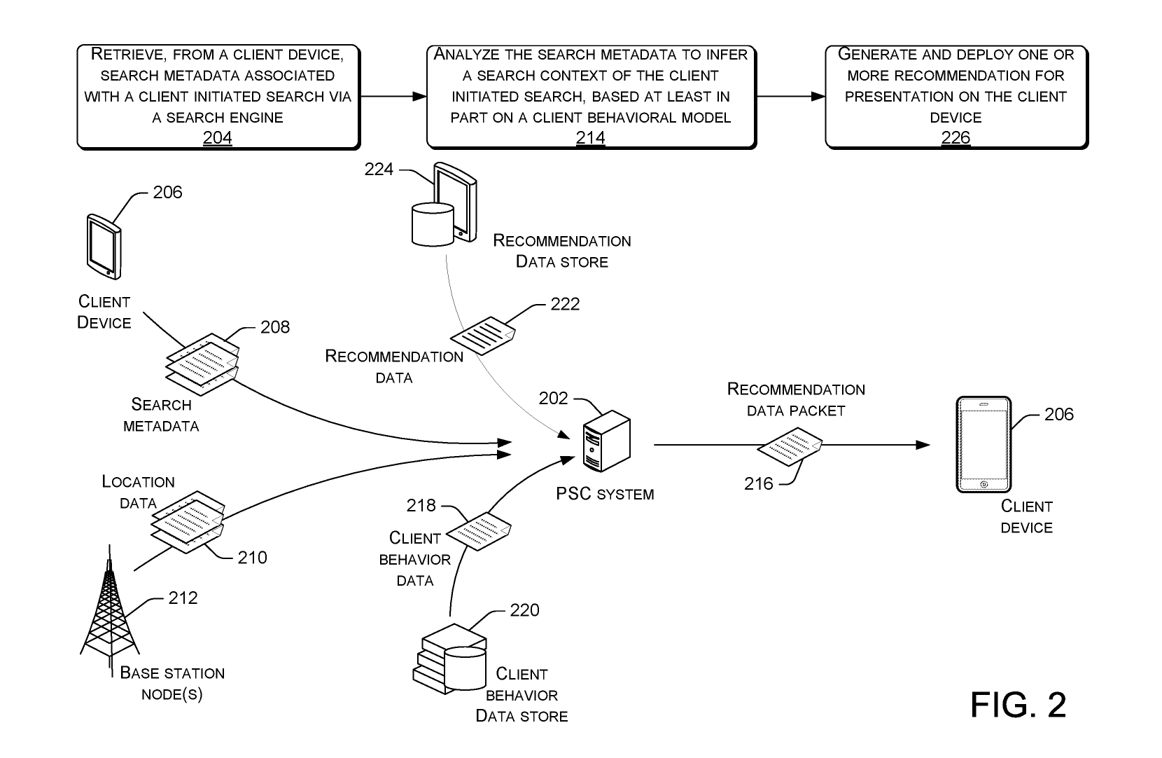

FIG. 2 illustrates a block diagram of a PSC system 202 that is configured to analyze search metadata associated with a client-initiated search and further present at least one recommendation to the client device that performed the client-initiated search. In some examples, the recommendation may correspond to an event, merchant, place, location, product, service, and/or a category thereof.

At block 204, the PSC system 202 may retrieve, from a client device 206 operating on a telecommunications network, search metadata 208 associated of a client-initiated search performed on an internet search engine. The search metadata 208 may describe information about a client-initiated search, without expressly reciting keywords entered by the client performing the search. For example, the search metadata 208 may include one or more of a device identifier associated with the client device 206 that performed the client-initiated search, an Internet Protocol (IP) address that corresponds to a subsequent internet search result, a number of bits associated with a character string (i.e., character string of the keyword(s) entered by the client) of the client-initiated search, or a time-stamp associated with the client-initiated search.

Further, the PSC system 202 may retrieve location data 210 from one or more base station node(s) 212 associated with the telecommunications network using the device identifier (i.e., from the search metadata 208) that is associated with the client device 206. In one example, the device identifier may correspond to IMEI number. The IMEI number may be used to retrieve a geographic location of the client device 206 from a base-station node associated with the telecommunications network.

At block 214, the PSC system 202 may analyze the search metadata 208 and the location data 210 to generate a recommendation data packet 216. More specifically, the PSC system 202 may determine one or more search contexts that correspond to a client-initiated search, based at least in part on the search metadata associated with the client-initiated search. More specifically, the PSC system may retrieve client behavior data 218 associated with the client from a client behavior data store 220. In some examples, the client behavior data 218 (i.e., a client behavior model) may include instances of historical search metadata associated with historical client-initiated searches performed by the client, and corresponding associations to search contexts. Further, the PSC system may analyze data patterns between search metadata 208 associated with the client and instances of historical metadata (i.e., client behavior data 218) associated with the client. Further, the PSC system may assign a similarity score to each instance of historical search metadata relative to the search metadata 208 associated with the client-initiated search. Each similarity score may reflect a degree of correlation between an instance of historical search metadata and the search metadata 208.

Moreover, the PSC system may select instances of historical search metadata with a similarity score that is greater than a predetermined similarity threshold. The PSC system may further determine one or more search contexts for the search metadata 208, based at least in part on historical search contexts associated with each of the selected instances of historical search metadata.

In various examples, the PSC system may retrieve recommendation data 222 from a recommendation data store 224, based at least in part on the one or more search contexts. The recommendation data 222 may include one or more recommendations for presentation to the client device 206, based at least in part on the one or more search contexts. The recommendations may relate to an event, merchant, place location, product, service, and/or category thereof. Further, the PSC system 202 may assign a suitability score to each recommendation, based on a degree of correlation of each recommendation and client behavior data 218 associated with the client. In doing so, the PSC system 202 may select one or more recommendations for presentation to the client device 206, based on a suitability score for each selected recommendation being greater than a predetermined suitability threshold.

At block 226, the PSC system may generate a recommendation data packet 216 for transmission to the client device 206. The recommendation data packet 216 may include computer executable instructions that automatically present each selected recommendation on a user interface of the client device 206.

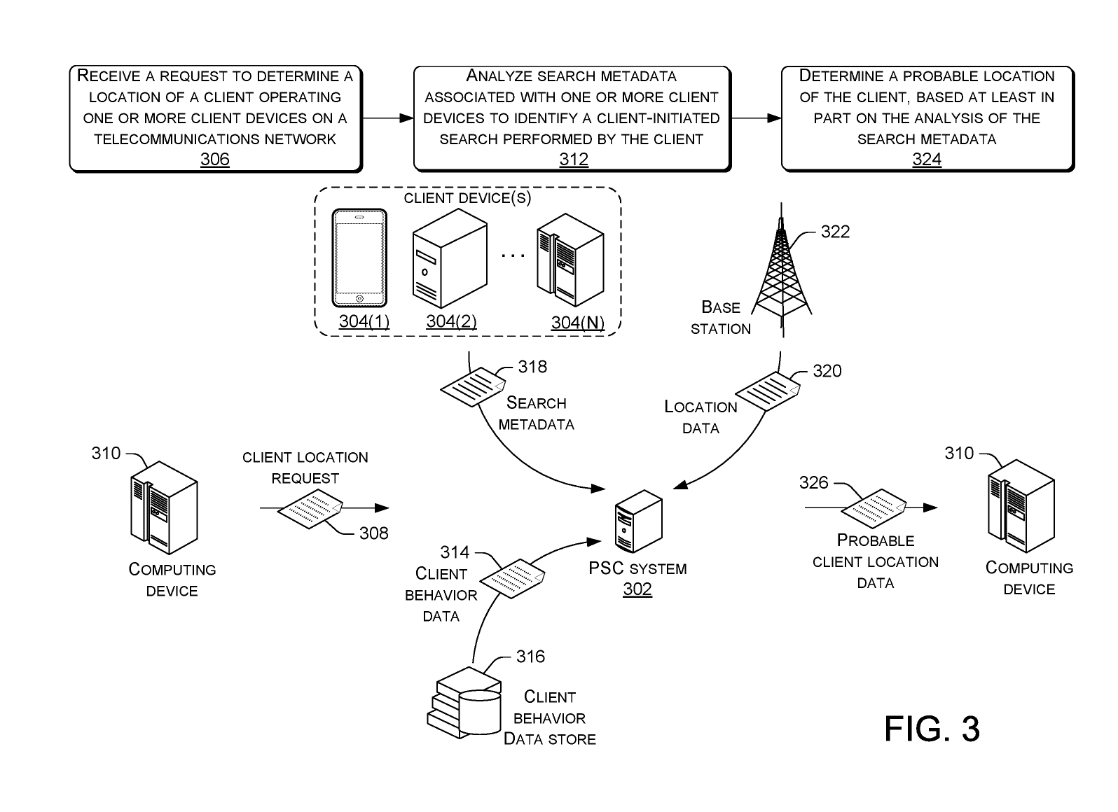

FIG. 3 illustrates a block diagram of a PSC system 302 that is configured to determine a next, or near to next, probable location of a client, based on instances of historical client-initiated searches performed on one or more client device(s) 304(1)-304(N) operating on a telecommunications network. The PSC system 302 may correspond to PSC system 102 or 202.

At block 306, the PSC system 302 may receive a client location request 308 to determine a location of a client operating one or more client device(s) 304(1)-304(N) on a telecommunications network. In some examples, the PSC system 302 may receive the client location request 308 from a computing device 310 associated with law enforcement personnel, a legal partner of the client, or a legal guardian of the client, all of whom may be attempting to intercept the client. The computing device 310 may correspond to computing device 114.

At block 312, the PSC system 302 may retrieve client behavior data 314 associated with the client identified in the client location request 308, from a client behavior data store 316. The client behavior data 314 may comprise of a client behavior model. The PSC system 302 may further identify one or more client device(s) 304(1)-304(N) that may be operated exclusively, or non-exclusively by the client. An exclusive client device may be a personal client device. Alternatively, a non-exclusive client device may be a workplace computer shared among employees, a computing device shared among family members, or a computing device shared among a membership of public or private community members. The PSC system 302 may associate a non-exclusive client device with the client based on one instance, at a point in time, of the client having authenticated their identity to the telecommunications network using the non-exclusive client device.

Further, the PSC system 302 may monitor instances of client-initiated searches performed by the one or more client device(s) 304(1)-304(N). The PSC system 302 may further retrieve and analyze the search metadata 318 associated with monitored instances of client-initiated searches. More specifically, the PSC system 302 may use one or more trained machine learning models that correlate data patterns between the search metadata 318 and the client behavior data 314 associated with the client.

Moreover, the PSC system 302 may determine that a particular client-initiated search performed by a particular client device (i.e., one of client device(s) 304(1)-304(N)) was performed by the client, based on the analysis of the search metadata 318 relative to the client behavior data 314. In doing so, the PSC system 302 may retrieve location data 320 from a base station node 322 associated with the telecommunications network, using a device identifier associated with the particular client device.

At block 324, the PSC system 302 may determine a next, or near to next, probable location of the client based at least in part on the location data 320 of the particular client device, or based on a search context related to the particular client-initiated search (i.e., search metadata), itself. For example, the particular client-initiated search may relate to a live music event that is to be performed at a particular music venue. Provided the search context similarly corresponds to the live music event, the PSC system 302 may surmise that a next, or near to next, probable location of the client is the live music event.

Moreover, the PSC system 302 may generate and transmit a probable location data packet 326 for transmission to computing device 310. The probable location data packet 326 may include computer executable instructions that automatically presented a next, or near to next, location of the client to a user interface of the computing device 310.

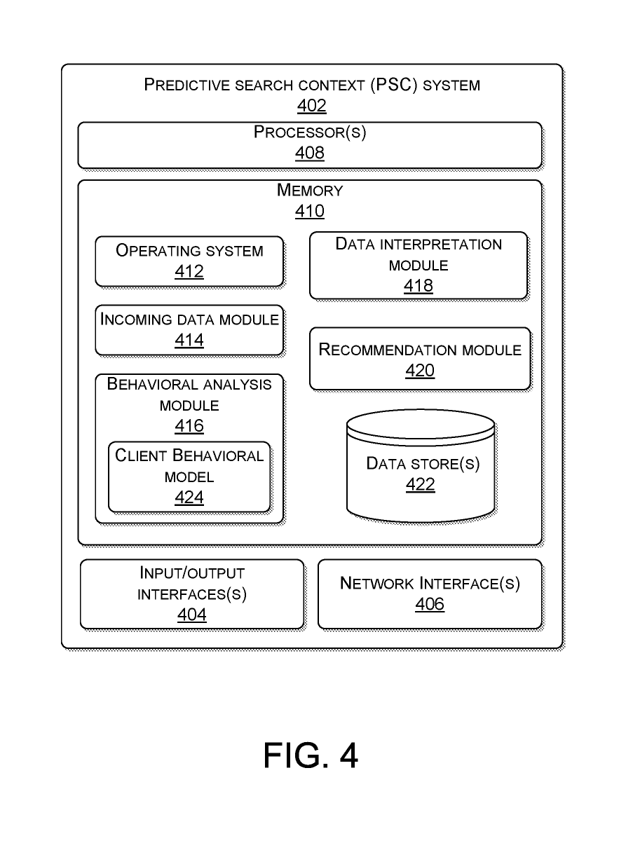

FIG. 4 illustrates a block diagram of a PSC system 402 that can analyze search metadata associated with a client-initiated search performed via an internet search engine. The PSC system may correspond to PSC system 102, 202, or 302. In one example the PSC system 402 may analyze the search metadata relative to client behavior data to provide a client with one or more recommendations. The recommendations may relate to an event, merchant, place, location, product, service, and/or category thereof. In another example, the PSC system 402 may use client behavior data (i.e., client behavior model) associated with a client, to predict a next, or near to next, probable location of the client.

In this example, the PSC system 402 may generate client behavior data based on client-initiated searches performed on client devices that are operated exclusively or non-exclusively by the client. In doing so, the PSC system 402 may analyze search metadata associated with one of the client devices to identify the client and determine a next, or near to next, probable location of the client.

In the illustrated example the PSC system 402 may include routines, program instructions, objects, and/or data structures that perform particular tasks or implement abstract data types. Further, the PSC system 402 may include input/output interface(s) 404. The input/output interface(s) 404 may include any type of output interface known in the art, such as a display (e.g., a liquid crystal display), speakers, a vibrating mechanism, or a tactile feedback mechanism. Input/output interface(s) 404 also include ports for one or more peripheral devices, such as headphones, peripheral speakers, or a peripheral display. Further, the input/output interface(s) 404 may further include a camera, a microphone, a keyboard/keypad, or a touch-sensitive display. A keyboard/keypad may be a push button numerical dialing pad (such as on a typical telecommunication device), a multi-key keyboard (such as a conventional QWERTY keyboard), or one or more other types of keys or buttons, and may also include a joystick-like controller and/or designated navigation buttons, or the like.

Additionally, the PSC system 402 may include network interface(s) 406. The network interface(s) 406 may include any sort of transceiver known in the art. For example, the network interface(s) 406 may include a radio transceiver that performs the function of transmitting and receiving radio frequency communications via an antenna. In addition, the network interface(s) 406 may also include a wireless communication transceiver and a near field antenna for communicating over unlicensed wireless Internet Protocol (IP) networks, such as local wireless data networks and personal area networks (e.g., Bluetooth or near field communication (NFC) networks). Further, the network interface(s) 406 may include wired communication components, such as an Ethernet port or a Universal Serial Bus (USB).

Further, the PSC system 402 may include one or more processor(s) 408 that are operably connected to memory 410. In at least one example, the one or more processor(s) 408 may be a central processing unit(s) (CPU), graphics processing unit(s) (GPU), a both a CPU and GPU, or any other sort of processing unit(s). Each of the one or more processor(s) 408 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. The one or more processor(s) 408 may also be responsible for executing all computer applications stored in the memory, which can be associated with common types of volatile (RAM) and/or nonvolatile (ROM) memory.

In some examples, memory 410 may include system memory, which may be volatile (such as RAM), non-volatile (such as ROM, flash memory, etc.) or some combination of the two. The memory may also include additional data storage devices (removable ad/or non-removable) such as, for example, magnetic disks, optical disks, or tape.

The memory 410 may further include non-transitory computer-readable media, such as volatile and nonvolatile, removable and non-removable media implemented in any method or technology for storage of information, such as computer readable instructions, data structures, program modules, or other data. System memory, removable storage and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

In the illustrated example, the memory 410 may include an operating system 412, an incoming data module 414, a behavior analysis module 416, a data interpretation module 418, a recommendation module 420, and one or more data store(s) 422. The operating system 412 may be any operating system capable of managing computer hardware and software resources.

The incoming data module 414 may retrieve search metadata of a client-initiated search that is conducted via an internet search engine by one or more client device(s) operating on a telecommunications network. The search metadata may describe information about a client-initiated search, without expressly reciting keywords entered by the client. By way of example, search metadata may include a device identifier associated with the client device performing the client-initiated search, an Internet Protocol (IP) address that corresponds to a subsequent internet search result, a number of bits associated with a character string (i.e., character string of the keyword(s) entered by the client) of the client-initiated search, or a time-stamp associated with the client-initiated search.

Further, the incoming data module 414 may monitor one or more client device(s) for the purpose of retrieving search metadata associated with client-initiated searches. Monitoring may occur on a continuous basis, per a predetermined schedule, or in response to a triggering event. The predetermined schedule may be based on a time interval of 30 minutes, one hour, 12 hours, or 24 hours. Any time interval is possible. Further, the triggering event may correspond to receipt of an indication, from a client device, that the client-initiated search has been performed. In some examples, the incoming data module 414 may monitor a select the client device(s) based at least in part on geographic locations that the client has visited frequently over a predetermined time interval. In one example, the incoming data module 414 may select the client device(s) based on client profile data associated with the client, or search contexts associated with instances of historical search metadata. In the latter example, the incoming data module 414 may receive an indication of geographic locations frequently visited by the client from the client behavior data via the data interpretation module 418, as discussed below.

The behavior analysis module 416 may generate client behavior data that describes client interests, preferences, and behavior, based at least in part on search metadata retrieved from one or more client devices. The client behavior data may include instances of historical search metadata associated with a client or client device, corresponding associations to instances of historical search contexts, client profile data associated with a client, or any combination thereof. Additionally, client behavior data may include associations to recommendations previously presented to a client, based on historical search metadata and corresponding search contexts.

In one example, the behavior analysis module 416 may develop a client behavior model 424, based at least in part on the client behavior data. The client behavior model 424 may describe a client's internet search behavior over a predetermined applicability period. In one example, the client behavior model 424 may be refined to remove search metadata that predate a predetermined applicability period. In this way, the client behavior model may continuously reflect a client's most recent internet search habits. Moreover, the client behavior model 424 may include associations to search contexts and recommendations, as determined by the data interpretation module 418 and the recommendation module 420 of the PSC system 402, respectively.

The data interpretation module 418 may analyze data patterns between the search metadata associated with a client-initiated search and client behavior data associated with the client. Particularly, the data interpretation module 418 may use both machine learning and non-machine learning techniques such as decision tree learning, association rule learning, artificial neural networks, inductive logic, Support Vector Machines (SVMs), clustering, Bayesian networks, reinforcement learning, representation learning, similarity and metric learning, and sparse dictionary learning to extract the data patterns.

In some examples, the data interpretation module 418 may generate a similarity score for instances of historical search metadata (i.e., client behavior data) based on a degree of correlation to search metadata associated with a client-initiated search. By way of example, the similarity score may reflect a correlation of a number of components of search metadata with an instances of historical search metadata (i.e., client behavior data). The components of search metadata may include an IP address accessed by a client device subsequent to a client-initiated search, number of bits of character string, time-stamp that corresponds to the client-initiated search, device identifier, and/or so forth.

In some examples, the data interpretation module 418 may determine that a particular client-initiated search performed on a shared client device is performed by a particular client. A shared client device may correspond to a client device shared within a workplace, family, or community environment. In this example, the data interpretation module 418 may determine a similarity score for each instance of historical search metadata associated with a particular client relative to the search metadata associated with the particular client-initiated search. In doing so, the data interpretation module 418 may compare each similarity score with a predetermined similarity threshold, and further determine that the particular client-initiated search is performed by the particular client based on a similarity score of an instance of historical search metadata being greater than a predetermined similarity threshold.

Further, the data interpretation module 418 may determine one or more search contexts that relate to a client-initiated search, based at least in part on instances of historical search metadata and corresponding similarity scores. By way of example, a search context may correspond to one of an event, merchant, place, product, service, and/or a category thereof. In one example, the data interpretation module 418 may determine a subset of instances of historical search metadata (i.e., client behavior data) with similarity scores greater than a predetermined similarity threshold. The PSC system may further identify historical search contexts that are associated with each instance of historical search metadata within the subset. In doing so, the PSC system may determine one or more search contexts for the search metadata based at least in part on the historical search contexts within the subset.

Additionally, the data interpretation module 418 may determine a next, or near to next, probable location of a client based on analysis of client behavior data (i.e., a client behavior model 424) associated with the client. More specifically, the data interpretation module 418 may use one or more trained machine learning models to identify data patterns between instances of historical search metadata (i.e., client behavior data) associated with client-initiated searches. By way of example, the data interpretation module 418 may determine that on a particular day of the week and/or at a particular time of day, the client performs one or more client-initiated searches using a particular client device. Thus, the data interpretation module 418 may determine a next, or near to next, probable location of the client based on a geographic location of the particular client device on that particular day of the week and at that particular time of day.

Further, the data interpretation module 418 may determine a next, or near to next, probable location of a client based on a search context of recently performed client-initiated searches that relate to a particular event, merchant, place, location, product, or service. By way of example, consider a client performing a client-initiated search that relates to a particular product or service offered by a particular merchant. In this example, the PSC system may analyze the search metadata associated with the client-initiated search and identify a search context that corresponds to the particular product or service. In doing so, the PSC system may determine a next, or near to next, probable location of the client at the particular merchant during merchant operating hours.

Moreover, the data interpretation module 418 may analyze search metadata retrieved from exclusive and non-exclusive client devices operated by the client. In doing so, data interpretation module 418 may determine a similarity (i.e., similarity score) for each instance of search metadata relative to instances of historical search metadata associated with the client. The data interpretation module 418 may determine that a client-initiated search was performed on a client device (i.e., exclusive or non-exclusive) is likely associated with the client based on the similarity score being greater than a predetermined similarity threshold. Further, the PSC system may determine a next, or near to next, probable location of the client based on location data associated with the client device, or a search context related to the client-initiated search (i.e., search metadata), itself.

In some examples, the data interpretation module 418 may generate and transmit a probable location data packet to a computing device associated with the client location request. The probable location data packet may include computer-executable instructions that automatically present a next, or near to next, probable location of the client on a user-interface of the computing device.

The recommendation module 420 may retrieve one or more recommendations for presentation to a client device, based at least in part on search metadata associated with a client-initiated search. The one or more recommendations may relate to an event, merchant, place, product, service, and/or category thereof. Further, the recommendations may be specific to a geographic location, a time period, of a combination of both. The recommendation module 420 may generate a recommendation data packet for transmission to a client device. The recommendation data packet may include computer executable instructions that can automatically present one or more recommendations on a user interface of the client device.

More specifically, the recommendation module 420 may use an indication of a search context, as determined by the data interpretation module 418, to identify and retrieve the one or more recommendations. By way of example, consider a client performing a client-initiated search for information relating to a live music event. In this example, the data interpretation module 418 may analyze search metadata associated with the client-initiated search and determine a search context that relates to the genre of music associated with the live music event. In doing so, the recommendation module 420 may use the indication of the “genre” of music to provide one or more recommendations, such as, but not limited to, a music album or streaming service related to the genre, a place where artists perform music related to the genre, or a combination thereof. In some examples, the recommendation module 420 may use additional search metadata, such as a device identifier to determine the location of the client device that performed the client-initiated search. In doing so, the recommendation module 420 may further determine a geographic location of the client device at a point in time that the client device performed the client-initiated search. Further, the recommendation module 420 may present a recommendation of a live music event that is within a predetermined distance of the client device at the point in time that the client device performed the client-initiated search.

In one example, the recommendation module 420 may use one or more trained machine learning models to assign a suitability score to each recommendation retrieved from a data store. The suitability score may reflect a degree of correlation between each recommendation retrieved from the data store and client behavior data associated with the client. By way of example, the client behavior data may include instances of historical search metadata and associated search contexts, client interests, client preferences, geographic locations frequently visited by the client, or any combination thereof.

Additionally, the recommendation module 420 may selectively present at least one recommendation to the client device, based at least in part on the suitability score associated with the recommendation being greater than a predetermined suitability threshold.

The one or more data store(s) 422 of the PSC system 402 may include a recommendation data store and a client behavior data store. The recommendation data store may maintain recommendations for a plurality of clients that operate client devices on the telecommunications network. The data store may be maintained by an operator of the PSC system, an operator of the telecommunications service provider, or a combination of both.

The client behavior data store may include a client behavior model for individual clients that can be used to select a recommendation for presentation to a client device, or predict a next, or near to next, probable location of the client. Client behavior data may include one or more of instances of historical search metadata associated with a client or client device, corresponding associations to search contexts, client profile data associated with individual clients. Client profile data may include a residential address, a business address, employment status, employment place, level of education, and/or so forth.

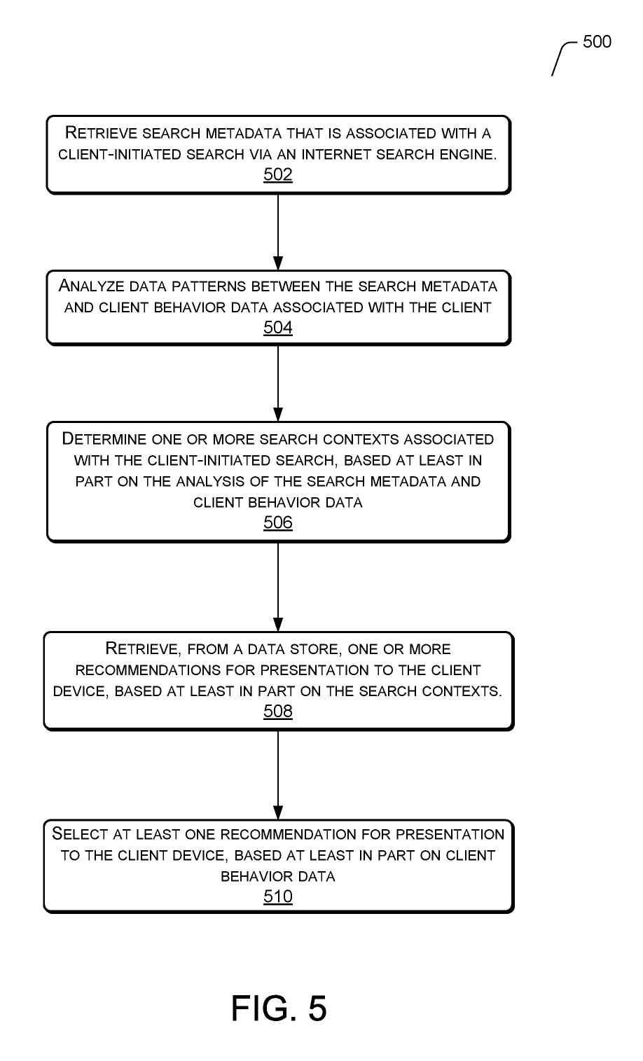

FIGS. 5, 6, 7, 8, and 9 present processes 500, 600, 700, 800, and 900 that relate to operations of the Predictive Search Context System. Each of processes 500, 600, 700, 800, and 900 illustrate a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 500, 600, 700, 800, and 900 are described with reference to the computing environment 100 of FIG. 1.

FIG. 5 illustrates a PSC system process to generate at least one recommendation to present to a client, in response to an analysis of search metadata of a client initiated search, via an internet search engine. In various examples, the client-initiated search may be performed on any client device associated with the client that is operating on a telecommunications network. Further, the recommendation presented to the client may relate to a search context of the client-initiated search, and may further target client interests and/or preferences, as determined by client behavior data associated with the client.

At 502, the PSC system may retrieve search metadata of a client-initiated search that is conducted via an internet search engine. The search metadata may describe information about a client-initiated search, without expressly reciting keywords entered by the client performing the search.

At 504, the PSC system may analyze data patterns between the search metadata and client behavior data associated with the client. The client behavior data may include instances of historical search metadata associated with a client or client device, corresponding associations to instances of historical search contexts, client profile data associated with a client, or any combination thereof. In some examples, the PSC system may use one or more trained machine learning models to determine a similarity between the search metadata and client behavior data associated with the client. By way of example, a similarity between search metadata and an instance of client behavior data (i.e., instance of historical metadata) may be expressed as a similarity score that is relative to a predetermined similarity threshold.

At 506, the PSC system may determine one or more search contexts that correspond to a client-initiated search, based at least in part on an analysis of the search metadata and client behavior data. In some examples, the PSC system may assign a similarity score to each instance of historical search metadata based on a degree of correlation of each instance of historical metadata to the search metadata. The PSC system may identify a subset of instances of historical search metadata with a similarity score relative to the search metadata that is greater than a predetermined similarity threshold. The PSC system may further identify historical search contexts that correspond to each instance of historical search metadata within the subset. The PSC system may further determine one or more search contexts for the search metadata based at least in part on these historical search contexts.

At 508, the PSC system may retrieve, from a data store, one or more recommendations for presentation to the client device, based at least in part on the one or more search contexts. The one or more recommendations may include events, merchants, places, locations, products, services, and/or categories thereof. Further, the recommendations may be specific to a geographic location, a time period, or a combination of both.

At 510, the PSC system may select at least one recommendation from the one or more recommendations retrieved from the data store, for presentation to the client device. In one example, the PSC system may use one or more trained machine learning models to determine data patterns between the client behavior data and the one or more recommendations retrieved from the data store. In doing so, PSC system may select at least one recommendation based on the degree of correlation between the recommendation and the client behavior data.

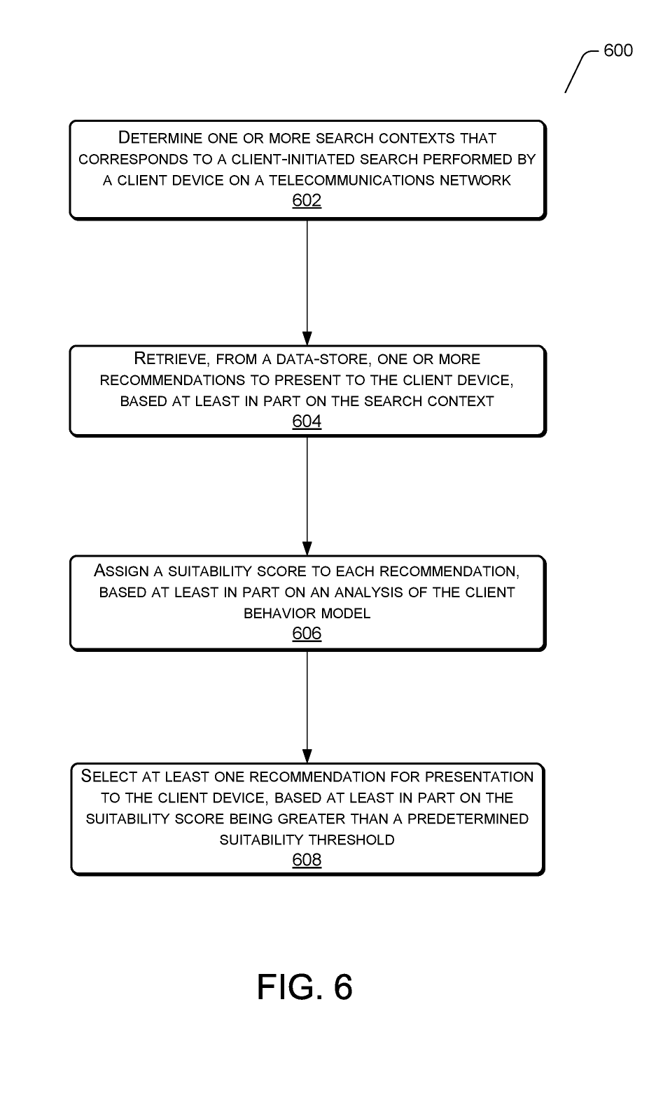

FIG. 6 illustrates a PSC system process to select at least one recommendation for presentation to a client device, based at least in part on an analysis of client behavior data. In various examples, the PSC system may generate a suitability score for each recommendation retrieved from a data store. The suitability score may reflect a degree of correlation between each recommendation and client behavior data associated with the client. In turn, the PSC system may selectively present recommendations to a client device, based on the suitability score of each recommendation being greater than a predetermined suitability threshold. In doing so, the PSC system may ensure that recommendations present to a client device are likely to align with a client's interests, preferences, and behaviors.

At 602, the PSC system may determine one or more search contexts that correspond to a client-initiated search performed by a client device operating on a telecommunications network. More specifically, the PSC system may analyze data patterns between search metadata associated with a client-initiated search and instances of historical search metadata (i.e., client behavior data) associated with the client. In some examples, the PSC system may use one or more trained machine learning models to assign a similarity score to each instance of historical search metadata based on a degree of correlation of each to the search metadata associated with the client-initiated search. In doing so, the PSC system may select the one or more search contexts that correspond to the instances of historical search metadata with an assigned similarity score relative to the client-initiated search that is greater than a predetermined similarity threshold.

At 604, the PSC system may retrieve, from a data-store, one or more recommendations for presentation to the client device, based at least in part on the one or more search contexts. The one or more recommendations may include events, merchants, places, locations, products, services, and/or categories thereof. Further, the recommendations may be specific to a geographic location, a time period, or a combination of both.

At 606, the PSC system may assign a suitability score to each recommendation retrieved from the data store. In some examples, the suitability score may reflect a degree of correlation between a recommendation and client behavior data associated with the client. Consider an example of a recommendation that corresponds to a location-specific event. The PSC system may determine a suitability score for the location-specific event (i.e., recommendation) based at least in part on an indication, within the client behavior data, that the client has visited that same, particular geographic location.

At 608, the PSC system may select a recommendation for presentation to the client device based at least in part on a comparison of the suitability score for each recommendation relative to a predetermined suitability threshold. More specifically, the PSC system may present a recommendation to a client device, based at least in part on determining that the suitability score associated with the recommendation is greater than a predetermined suitability threshold.

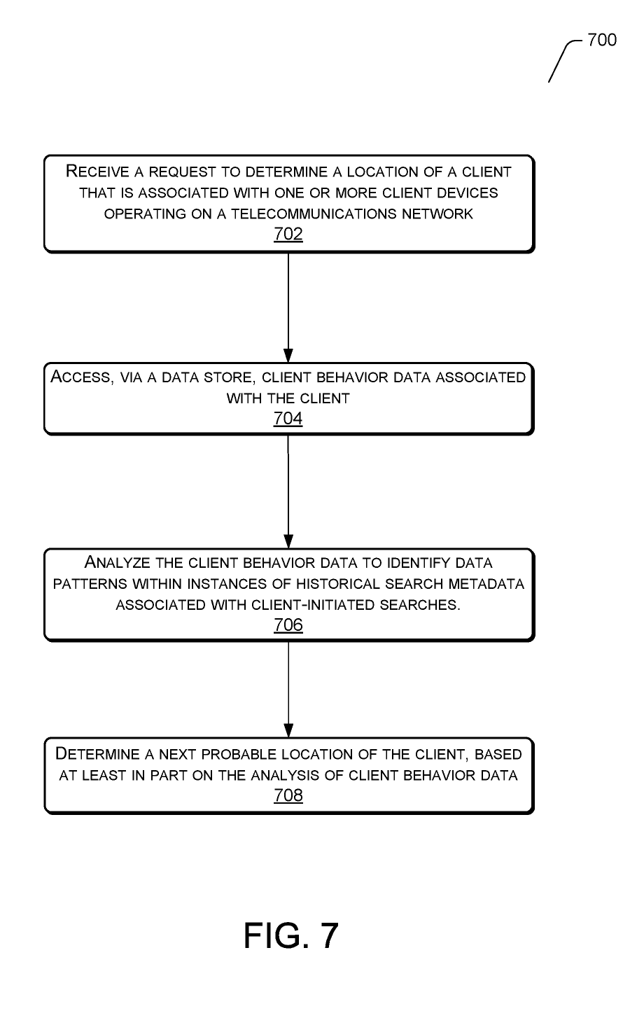

FIG. 7 illustrates a PSC system process to determine a next, or near to next, probable location of a client based on historical client-initiated searches performed on one or more client devices operating on a telecommunications network. In some examples, the request to determine a next, or near to next, probable location of a client may be received from law enforcement personnel, a legal partner of the client, or a legal guardian of the client, all of whom may be attempting to intercept the client.

At 702, the PSC system receives a request to determine a location of a client that is associated with one or more client devices operating on the telecommunications network. In some examples, the request may be received from law enforcement personnel, a legal partner, or a legal guardian, seeking to locate the whereabouts of an individual.

At 704, the PSC system may access, via a data store, client behavior data associated with the client. In one example, the client behavior data may comprise of a client behavior model that may be analyzed to predict a next, or near to next, probable location of the client based on historical client-initiated searches.

At 706, the PSC system may analyze the client behavior data to identify data patterns between instances of historical search metadata associated with client-initiated searches. By way of example, the PSC system may determine that a client typically performs a series of client-initiated searches from a particular client device on at a particular time of day.

At 708, the PSC system may determine a next, or near to next, probable location of the client, based at least in part on the analysis of the client behavior data. In some examples, the PSC system may retrieve the device identifier associated with the particular client device that performs the series of client-initiated searches. In doing so, the PSC system may interact with one or more base station(s) of the telecommunications network to retrieve location data associated with the particular client device.

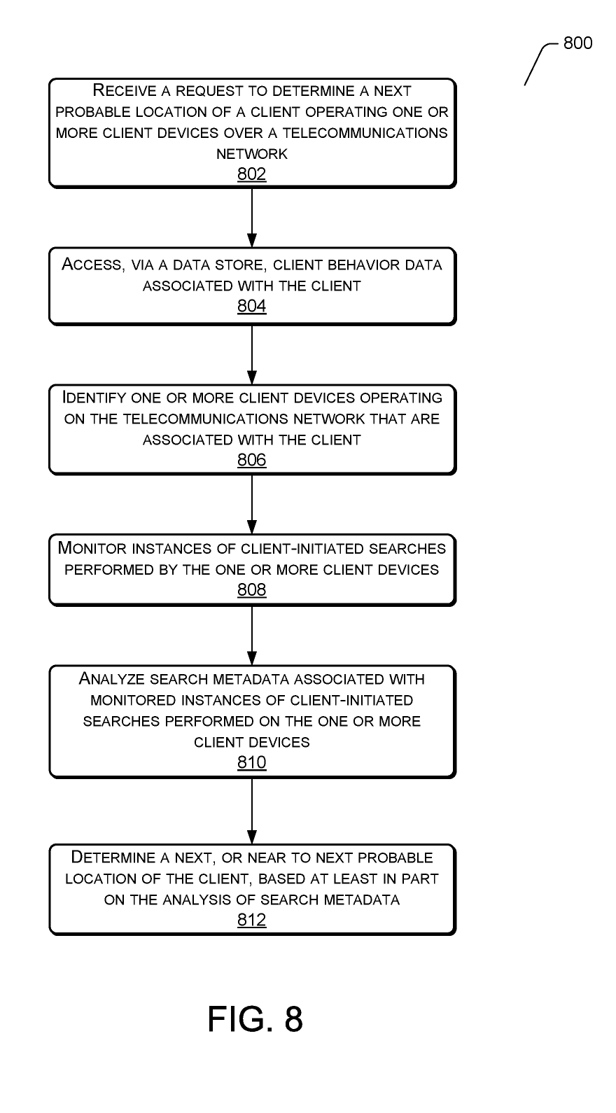

FIG. 8 illustrates a PSC system process to predict a next, or near to next, probable location of a client based on monitoring instances of client-initiated searches performed by one or more client devices that operated exclusively or non-exclusively by a client on the telecommunications network. In some examples, the one or more client devices may correspond to a client device shared within a workplace (i.e., a work-station computer shared among employees), family (i.e., computing device shared among family members), or a community environment (i.e., computing device shared among a membership of public or private community members).

At 802, the PSC system may receive a request to determine a next, or near to next, probable location of a particular client operating one or more client devices over a telecommunications network. The request may be received from law enforcement personnel, a legal partner of the client, or a legal guardian of the client, all of whom may be attempting to intercept the client at a next, or near to next, probable location.

At 804, the PSC system may access, via a data store, client behavior data associated with the client identified in the client location request. In one example, the client behavior data may comprise of a client behavior model that correlates search metadata associated with client-initiated searches performed by the client on the one or more client devices. It is noteworthy that the client behavior data is typically based on client-initiated searches performed on client devices exclusively operated by the client on the telecommunications network. The purpose of doing so is to avoid instances whereby another client using a shared client device is inadvertently identified as the client.

At 806, the PSC system may identify one or more client devices associated with the client that are operating on the telecommunications network. The one or more client devices may be operated exclusively, or non-exclusively by the client. For example, the one or more client devices may be a personal client device, a workplace computer shared among employees, a computing device shared among family members, or a computing device shared among a membership of public or private community members.

At 808, the PSC system may monitor instances of client-initiated searches performed by the one or more client devices on a continuous basis, per a predetermined schedule, or in response to a triggering event. In some examples, the PSC system may monitor exclusive, non-exclusive, or a combination of both client devices based on client behavior data. The client behavior data may identify a subset of client devices based on a client's most recently visited geographic locations, a particular day of the week, time of the day, and/or so forth.

At 810, the PSC system may analyze search metadata associated with monitored instances of client-initiated searches performed by the one or more client devices. Particularly, the PSC system may use one or more trained machine learning models to correlate data patterns between the search metadata that is retrieved from the one or more client devices and instances of historical search metadata associated with the client. In some examples, the PSC system may generate a similarity score for instances of historical search metadata based on a degree of correlation between each instance of historical search metadata and the search metadata.

At 812, the PSC system may determine a next, or near to next, probable location of the client, based at least in part on an analysis of the search metadata. More specifically, the PSC system may determine that a client-initiated search performed on a client device (i.e., exclusive client device or non-exclusive client device) was likely performed by the client based on the similarity score associated with the search metadata and an instance of historical search metadata being greater than a predetermined similarity threshold. In doing so, the PSC system may determine a next, or near to next, probable location of the client, based on a geographic location of the client device (i.e., exclusive client device or non-exclusive client device), or a search context related to the client-initiated search (i.e., search metadata), itself.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed:

1. A system comprising:
one or more processors;
memory coupled to the one or more processors, the memory including one or more modules that are executable by the one or more processors to:
receive a client location request that is associated with a client operating one or more client devices operating on a telecommunications network;
retrieve, from a data store, client behavior data associated with the client, the client behavior data including device identifiers of the one or more client devices, instances of historical search metadata that correspond to historical client-initiated searches performed by the client using the one or more client devices;
analyze the client behavior data to determine data patterns between the instances of historical search metadata; and
determine a next location of the client based at least in part on the data patterns.

2. The system of claim 1, wherein the data patterns relate to one or more of a particular client device of the one or more client devices, a particular day of a week, a particular time of day, or a particular search context associated with a client-initiated search performed by the client.

3. The system of claim 1, wherein to analyze the client behavior data includes determining, at a regular point in time, that the client performs one or more client-initiated searches using a particular client device of the one or more client devices, and wherein the one or more modules are further executable by the one or more processors to:
determine a device location of the particular client device, based at least in part on a device identifier associated with the particular client device, and
wherein to determine the location of the client is based at least in part on the device location at the regular point in time.

4. The system of claim 1, wherein the one or more modules are further executable by the one or more processors to:
generate a client behavior model associated with the client to that correlate data patterns between instances of historical search metadata, and
wherein to analyze the client behavior data, is further based at least in part on an analysis of the client behavior model to identify data patterns between one or more of instances of historical search metadata or corresponding search contexts.

5. The system of claim 1, wherein the one or more modules are further executable by the one or more processors to:
monitor instances of current search metadata associated with client-initiated searches performed by the one or more client devices, the instances of current search metadata including a corresponding device identifier associated with a client device that conduct the client-initiated search; and
determine a similarity between the instances of current search metadata and the instances of historical search metadata associated with the client, and
wherein to analyze the client behavior data is further based at least in part on the similarity between at least one of the instances of current search metadata and at least one of the instances of historical search metadata being greater than a predetermined similarity threshold.

6. The system of claim 1, wherein the one or more modules are further executable by the one or more processors to:
identify search contexts associated with the instances of historical search metadata, the search contexts including one of an event, a place, a location, a product, a service, or a category thereof; and
identify at least one search context of the search contexts that occurs at a particular location and at a particular time, and
wherein to determine the next location of the client is further based at least in part on the particular location and at the particular time that is associated with the at least one search context.

7. The system of claim 1, wherein the one or more modules are further executable by the one or more processors to:
determine a search context for individual ones of the instances of historical search metadata, the search context relating to one of an event, a category of events, a merchant, a category of merchants, a place, or a category of places;
identify one or more geographic locations that the client is likely to visit during a predetermined time interval, based at in part on instances of historical search metadata and corresponding search contexts; and
identify the one or more client devices, based at least in part on a proximity of the one or more client devices to the one or more geographic locations.

8. The system of claim 1, wherein the instances of historical search metadata include one or more of a time-stamp associated with a corresponding client-initiated search, an Internet Protocol (IP) address associated with a corresponding internet search result, and a number of bits associated with a character string of the client-initiated search.

9. One or more non-transitory computer-readable media storing computer executable instructions that, when executed on one or more processors, cause the one or more processors to perform acts comprising:
receiving a request for a location of a client, the client being associated with one or more client devices operating on a telecommunications network;
retrieve, from a data store, client behavior data associated with the client, the client behavior data including device identifiers of the one or more client devices, instances of historical search metadata that correspond to historical client-initiated searches performed by the client using the one or more client devices;
generating a client behavior model associated with the client to identify data patterns between instances of current search metadata and instances of historical search metadata associated with the client, the client behavior model being based at least in part on client behavior data;
retrieve instances of current search metadata associated with the one or more client devices;
analyzing the instances of current search metadata relative to the client behavior model to identify data patterns between the instances of current search metadata and the instances of historical search metadata; and
determining the location of the client, based at least in part on an analysis of the client behavior model.

10. The one or more non-transitory computer-readable media of claim 9, further comprising:
monitoring the one or more client devices to identify instances of current search metadata associated with current client-initiated searches, the instances of current search metadata including at least corresponding device identifiers of the one or more client devices; and
determining individual locations associated with the instances of current search metadata, based at least in part on the corresponding device identifiers of the one or more client devices.

11. The one or more non-transitory computer-readable media of claim 9, wherein analyzing the client behavior model further includes determining a similarity score of individual instances of the current search metadata and the instances of historical search metadata associated with the client, and
wherein, determining the location of the client is further based at least in part on the similarity score of one of the individual instances of the current search metadata and one of the historical instances of search metadata being greater than a predetermined similarity threshold.

12. The one or more non-transitory computer-readable media of claim 9, wherein the instances of current search metadata include a number of bits associated with a character string of the client-initiated search, an Internet Protocol (IP) address that corresponds to a subsequent internet search result.

13. The one or more non-transitory computer-readable media of claim 9, further comprising:
identifying search contexts associated with instances of historical search metadata, the search contexts including one of an event, a category of events, a merchant, a category of merchants, a place, or a category of places, and
wherein determining the location of the client is based at least in part on the search contexts associated with the instances of historical search metadata.

14. The one or more non-transitory computer-readable media of claim 9, further comprising:
identifying one or more geographic locations that the client is likely to visit, based at least in part on client profile data associated with the client and search contexts associated with the instances of historical search metadata; and
selecting the one or more client devices for monitoring, based at least in part on a proximity of the one or more client devices to the one or more geographic locations.

15. The one or more non-transitory computer-readable media of claim 9, further comprising:
generating modified client behavior data associated with the client by adding instances of current search metadata;
removing a portion of client behavior data from the modified client behavior data that is associated with a time-stamp beyond a predetermined time interval; and
updating the client behavior model, based at least in part on the modified client behavior data.

16. A computer-implemented method, comprising:
under control of one or more processors:
receiving a request for a location of a client, the client being associated with one or client devices operating on a telecommunications network;
monitoring instances of current search metadata associated with client-initiated searches on one or more client devices;
retrieving, from a data store, client behavior data associated with the client, the client behavior data including instances of historical search metadata and corresponding search contexts;
analyzing the client behavior data to identify a similarity between the instances of current search metadata and the instances of historical search metadata;
identifying a particular instance of current search metadata based at least in part on a similarity between the particular instance of current search metadata and one of instances of historical search metadata being greater than a predetermined similarity threshold, the particular instance of current search metadata including a device identifier of a client device that performed a corresponding client-initiated search; and
determining the location of the client, based at least in part on the device identifier associated with the particular instance of the current search metadata.

17. The computer-implemented method of claim 16, further comprising:
generating a client behavior model associated with the client to identify data patterns between the instances of current search metadata and the instances of historical search metadata, based at least in part on the client behavior data, and
wherein to analyze the client behavior data to identify a similarity between the instances of current search metadata and the instances of historical search metadata, is further based at least in part on the client behavior model.

18. The computer-implemented method of claim 17, further comprising:
generating modified client behavior data associated with the client by adding instances of the current search metadata; and
updating the client behavior model, based at least in part on the client behavior data.

19. The computer-implemented method of claim 16, wherein the instances of current search metadata further include a time-stamp associate with a corresponding client-initiated search, an Internet Protocol (IP) that corresponds to a corresponding internet search result.

20. The computer-implemented method of claim 16, further comprising:
identifying search contexts associated with the instances of historical search metadata, the search contexts corresponding to corresponding to one of an event, a category of events, a merchant, a category of merchants, a place, or a category of places; and
associating a search context of at least one instance of historical search metadata to at least one instance of current search metadata, based at least in part on the similarity of the at least one instance of historical search metadata and the at least one instance of current search metadata being greater than a predetermined similarity threshold, and
wherein, determining the location of the client is further based at least in part on the search context of the at least one current search metadata.
